(19) United States
(12) Patent Application Publication
(10) Pub. No.: US 2007/0005420 A1
(43) Pub. Date: Jan. 4, 2007

(54) Adjustment of inventory estimates

(75) Inventors: Ashis K. Roy, Kirkland, WA (US); Lawrence A. Koch, Seattle, WA (US); Jonathan E. Fay, Woodinville, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/172,170

(22) Filed: Jun. 30, 2005

(51) Int. Cl. G06Q 30/00

(52) U.S. Cl. 705/14

(57) ABSTRACT

A system and method for estimating available payload inventory are provided. An advertisement delivery system generates a set of atomic market segment arrays from target market criteria for one or more advertisement campaigns to be served. The advertisement delivery system predicts future capacity and manages inventory utilizing forecasting methods and the manual adjustment of forecast values. The manual adjustment techniques include utilizing seed values, adjustment factors and/or proxy values.

### BACKGROUND

Generally described, multi-person networks, such as the Internet, facilitate the interaction of computer users and the exchange of a variety of information. More specifically, the Internet has recently seen explosive growth by virtue of its ability to link computers located throughout the world. Often, a Web site provider is able to provide content, and or services, to computer users at a reduced cost, or even free, by generating advertisement revenue from one or more advertisement providers. For example, a merchant can contract with a Web site provider to pay the Web site provider to display the merchant's advertisements along with the Web site content. The contracting merchant can be generally referred to as an advertisement provider.

With regard to Web sites that are accessed by a large number of users, such as a portal Web site, the Web site provider may contract with a number of advertisements providers to display an advertisement a certain number of times over a given time period, generally referred to as an advertisement campaign. Additionally, each advertisement provider may also include criteria, such as a “male, age=30 to 35,” that limits to whom the advertisement may be displayed. In such an embodiment, the Web site provider utilizes one or more criteria, such as user demographics and/or inputted keywords, obtained from the content requesting user to select an appropriate advertisement from a group of applicable advertisements. The satisfaction of advertisement provider criteria is generally referred to as a display opportunity.

In order to accommodate for large number of users requesting content and thereby requiring one or more advertisements, some Web site providers utilize an advertisement delivery system to track and deliver advertisements to the Web site provider. Often, the advertisement delivery system negotiates with various advertisement providers such that the advertisement delivery system may have to concurrently process several advertisement campaigns. Accordingly, a primary focus of the advertisement delivery system relates to the selection of an advertisement from a variety of potentially applicable advertisements so as to better comply with the contractual obligations of the current advertisement campaigns. For example, advertisement delivery systems may implement various methods to accommodate for variations in the number of display opportunities.

In addition to the selection of advertisements to satisfy current advertisement campaigns, another primary focus of an advertisement delivery system relates to future display opportunity processing. In a capacity planning aspect, the advertisement delivery system utilizes an estimated number of future display opportunities to ensure that the advertisement delivery system has adequate system resources in terms of memory, processing capability, personnel to satisfy future advertisement delivery system obligations. In an available inventory aspect, the advertisement delivery system utilizes the estimated number of future display opportunities to maximize the amount of revenue that can be generated by the sale of all, or substantially all, the estimated future display opportunities.

Several advertisement delivery systems attempt to address issues relating to future display opportunities by sampling a certain percentage of current display opportunities and interpolating the sampled data to calculate future display opportunities. In accordance with this embodiment, an advertisement delivery system samples a selected percentage of the user requests for advertisements. The sampled request criteria are stored and are then statistically extrapolated to predict future display opportunities. For example, a sampling of 100,000 advertisement requests at a sampling rate of 1 user request out of every 1000 user requests would generate 100 data points. If the sampled user requests produce data indicative of 10 user requests including the selection criteria “gender=male” and “age=30 to 35,” then the conventional advertisement delivery system would assume that 10% of all the user requests would include those user request criteria. Accordingly, if 1,000,000 advertisement requests were predicted for the following day, the conventional advertisement delivery system would assume that 100,000 of the requests would contain the selection criteria “gender=male” and “age=30 to 35” and would attempt to sell a sufficient number of advertisements that could be satisfied by the criteria.

Conventional sampling methods, however, can become deficient for smaller volume advertisement campaigns that have more specific user request criteria to match. For example, assume that an advertisement campaign requires that a particular set of criteria must be matched before the advertisement can be displayed and that the particular set of criteria is only appears 500 times over 350,000 user requests. Utilizing a sampling method, it would be very likely that an advertisement delivery system would detect few, if any, of the user requests satisfying the particular set of criteria. Accordingly, conventional advertisement delivery systems would incorrectly estimate the available inventory and potentially lose a portion of its revenue generating stream. Moreover, conventional sampling methods would also discourage selling smaller advertisement campaigns, as there would be little way of monitoring the performance of the advertisement delivery system.

In addition to the problems associated with sampling target opportunities for smaller advertisement campaigns, advertisement delivery systems may also have difficulty in predicting future inventory availability during the initial phases of an advertisement campaign, when a statistically insignificant amount of data has been collected. Additionally, advertisements system may also have difficulty in adjusting future inventory availability to account for variations in inventory, such as seasonal, cyclical or event driven occurrences. In one aspect, over predicting inventory can lead to the under delivery of advertisements. In another aspect, under predicting inventory can lead to lost revenue and the dilution of advertisement sales.

### SUMMARY

A system and method for estimating available payload inventory are provided. An advertisement delivery system generates a set of atomic market segment arrays from target market criteria for one or more advertisement campaigns to be served. The advertisement delivery system predicts future capacity and manages inventory utilizing forecasting methods and and the manual adjustment of forecast values. The manual adjustment techniques include utilizing seed values, adjustment factors and/or proxy values.

In accordance with an aspect of the present invention, a method for processing payload requests is provided. An advertisement delivery system obtains a set of criteria for delivering at least one payload associated with an advertisement campaign. The set of criteria including one or more criterion for associating an advertisement with requested content. The advertisement delivery system generates a set of arrays corresponding to each criterion in the set of criteria. The set of arrays include a number of array elements that correspond to discrete units of time.

The advertisement delivery system then processes the numerical identifiers in the set of arrays to predict an estimated number of future payload requests. The prediction of future payload requests can utilize traditional trend analysis. The advertisement delivery system then manually adjusts at least a portion of the predicted future payload requests utilizing various manual adjustment techniques. The manual adjustment techniques can include applying fixed seed values, applying adjustment factors to the predicted value, associating a proxy value, and/or a combination of techniques.

In accordance with another aspect of the present invention, a system for processing payload requests is provided. The payload requests are associated with a set of payload criteria. The system includes a payload processor that obtains the payload criteria and generate a set of arrays corresponding to each criterion in the set of payload criteria. The system also includes a payload manager that obtains the set of arrays and to process data within the set of arrays to generate an estimated number of future payload requests. The payload manager manually adjusts at least a portion of the estimated number of future payload requests.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a content and advertisement delivery system operable to process the user request criteria to estimate advertisement display opportunity inventory in accordance with an aspect the present invention;

FIG. 2 is a block diagram of the advertisement content and delivery system of FIG. 1 illustrating the generation of atomic market segment arrays from the advertisement campaigns in accordance with the present invention;

FIG. 3 is a flow diagram illustrative of an advertisement market segment processing routine performed by an advertisement delivery system in accordance with an aspect the present invention;

FIG. 4 is a block diagram illustrating the generation of one or more atomic market segment arrays corresponding to advertisement target market criteria in accordance with the present invention;

FIG. 5 is a block diagram of the content and advertisement delivery system of FIG. 1 illustrating the initiation of a user request in accordance with an aspect the present invention;

FIG. 6 is a block diagram of the content and advertisement delivery system of FIG. 1 illustrating the transfer of a request criteria and user identification information to an advertisement delivery system in accordance with an aspect the present invention;

FIG. 7 is a block diagram of the content and advertisement delivery system of FIG. 1 illustrating the transfer of the request criteria and the user identification information to an advertisement delivery system to generate additional user demographic information in accordance with an aspect the present invention;

FIG. 8 is a block diagram of the content and advertisement delivery system of FIG. 1 illustrating the parsing of the user request criteria and the user demographic information by an advertisement delivery system in accordance with an aspect the present invention;

FIG. 9 is a block diagram of the content and advertisement delivery system of FIG. 1 illustrating the transfer of processed atomic market segment data to an advertisement manager in accordance with an aspect the present invention;

FIG. 10 is a flow diagram illustrative of an advertisement request information processing routine implemented by an advertisement processing component of an advertisement delivery system in accordance with an aspect the present invention;

FIG. 11 is a block diagram of the atomic market segment arrays of FIG. 4 illustrating the population of array element by parsed advertisement request criteria in accordance with an aspect the present invention;

FIG. 12 is a block diagram illustrating the generation of a predicted number of advertisement display opportunities from overlapping market segments in accordance with an aspect the present invention;

FIG. 13 is a flow diagram illustrative of a routine for adjusting predictive future inventory in accordance with the present invention;

FIG. 14 is a block diagram illustrative of predictive and current values of inventory for a target advertisement campaign in accordance with an aspect of the present invention;

FIG. 15 is a block diagram of the predictive and current values of inventory for a target advertisement campaign of FIG. 14 illustrating a manual adjustment with seed values in accordance with an aspect of the present invention;

FIG. 16 is a block diagram of the predictive and current values of inventory for a target advertisement campaign of FIG. 14 illustrating a manual adjustment with adjustments in accordance with an aspect of the present invention; and

FIGS. 17A-17D are block diagrams of the predictive and current values of inventory for a target advertisement campaign of FIG. 14 illustrating a manual adjustment with proxy values and adjustments in accordance with an aspect of the present invention.

### DETAILED DESCRIPTION

The present invention relates to a system and method for estimating available payload inventory. More specifically, the present invention will be described in relation to a system and method for processing user request criteria to estimate advertisement display opportunity inventory utilizing manual adjustments. As will be readily understood by one skilled in the relevant art, the present invention is not limited to its application to the illustrative advertisement media delivery system and the embodiments disclosed are only done by way of example and should not be construed as limiting.

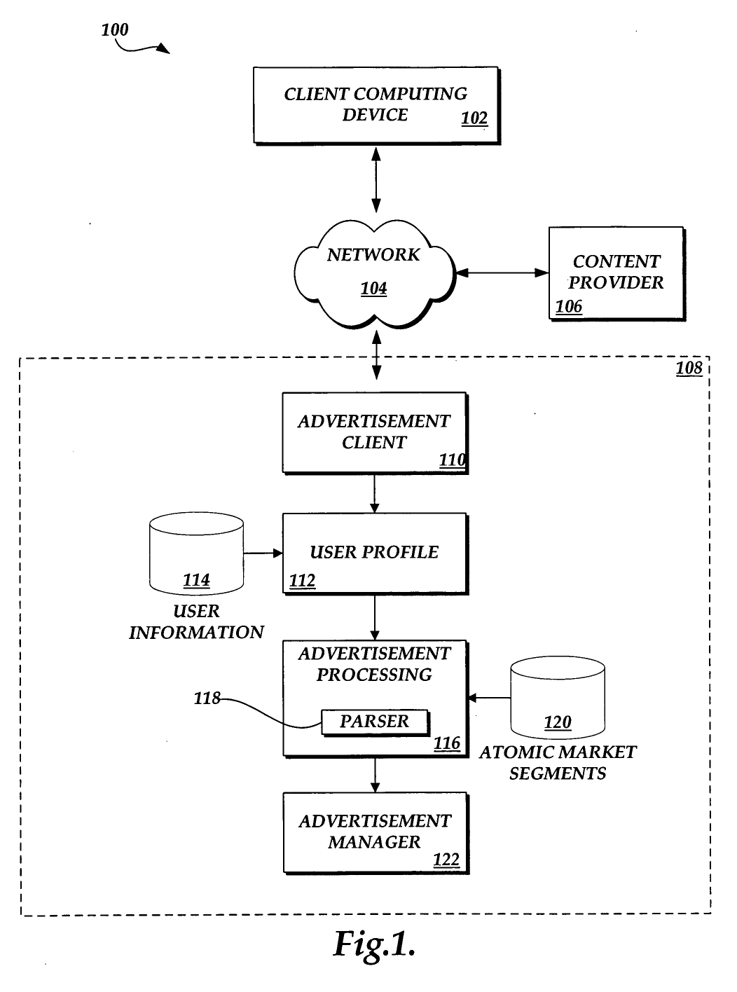

FIG. 1 is a block diagram illustrative of a content and advertisement delivery system 100 operable to process the user request criteria to estimate advertisement display opportunity inventory in accordance with the present invention. As illustrated in FIG. 1, the content and advertisement delivery system 100 includes one or more client computing devices 102 that are connected to a communication network, such as the Internet 104. In an illustrative embodiment of the present invention, the client computing devices 102 may be connected to the Internet 104 via an ISP (not shown). Alternatively, the client computing devices 102 may be connected directly to the Internet 104. The client computing devices 102 may have a browser software application that requests content from one or more content providers 106 via the Internet 104. Although only one client computing device 102 and content provider 106 are illustrated in FIG. 1, one skilled in the relevant art will appreciate that the content and advertisement delivery system 100 may include any number of client computing devices 102 and content providers 106.

In addition to providing the requested content to the client computing device 102, the content provider 106 may also issue a request to an advertisement delivery system 108 for one more advertisements that correspond to the requested content and/or one or more user demographics with the user associated with the client computing device 102. As illustrated in FIG. 1, the advertisement delivery system 108 includes an advertisement client component 120 operable to receive the request for advertisements. The advertisement delivery system 108 also includes a user profile component 112 that obtains one or more user identifiers and associate them with one or more records of a user information store 114.

With continued reference to FIG. 1, the advertisement delivery system 108 further includes an advertisement processing component 116 that is operable to obtain user request criteria and user information, select an advertisement for return to the content provider 106 and parse the selected advertisement's target information for future inventory processing. The advertisement processing component 116 can include a parser 118 for processing the advertisement's target data. In communication with the advertisement processing component 116 is an atomic market segment store 120 operable to store a number of atomic market segments for tracking advertisement requests. A more detailed description of an atomic market segment will be described below. The advertisement delivery system 108 also includes an advertisement manager component 122 operable to obtain the atomic market segment data and utilize the data for capacity planning and inventory management. As will be described in greater detail below, the advertisement manager component 122 can utilize manual techniques to modify predictions of future inventory. One skilled in the relevant art will appreciate that the advertisement delivery system 108 may include additional or alternative components and/or that one or more of the components may perform additional functions.

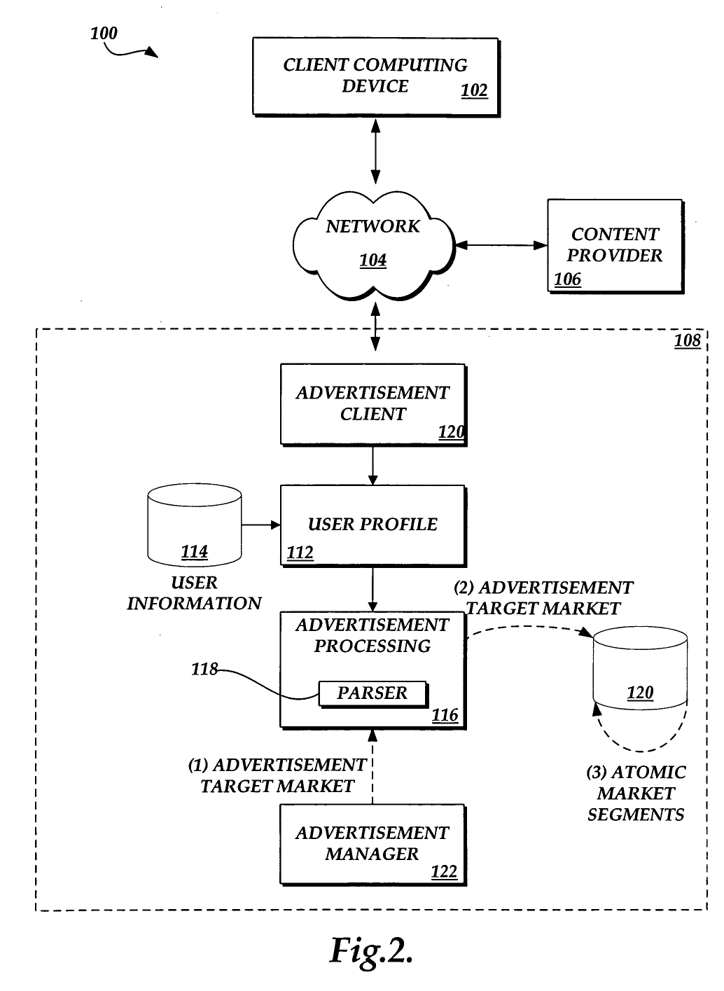

FIG. 2 is a block diagram of the advertisement content and delivery system 108 of FIG. 1 illustrating the generation of atomic market segment arrays from the advertisement campaigns in accordance with the present invention. The process can be initiated when the advertisement manager component 122 of the advertisement delivery system 108 transfers target market segment criteria for one or more advertisement campaigns to the advertisement processing component 116. The parser 118 obtains the target market segment criteria and generates an ordered list of the individual criterion within the target market segment criteria. The advertisement processing component 116 then transmits the ordered list of advertisement target market segment data to the atomic market segment store 120. The ordered list is stored in the atomic market segments store 120 as one or more atomic market segment arrays. As will be explained in greater detail below, the atomic market segment arrays stored in the atomic market segment store 120 can be utilized by the advertisement processing component 116, and other components, to track a number of incoming advertisement requests and to predict future capacity planning and inventory data.

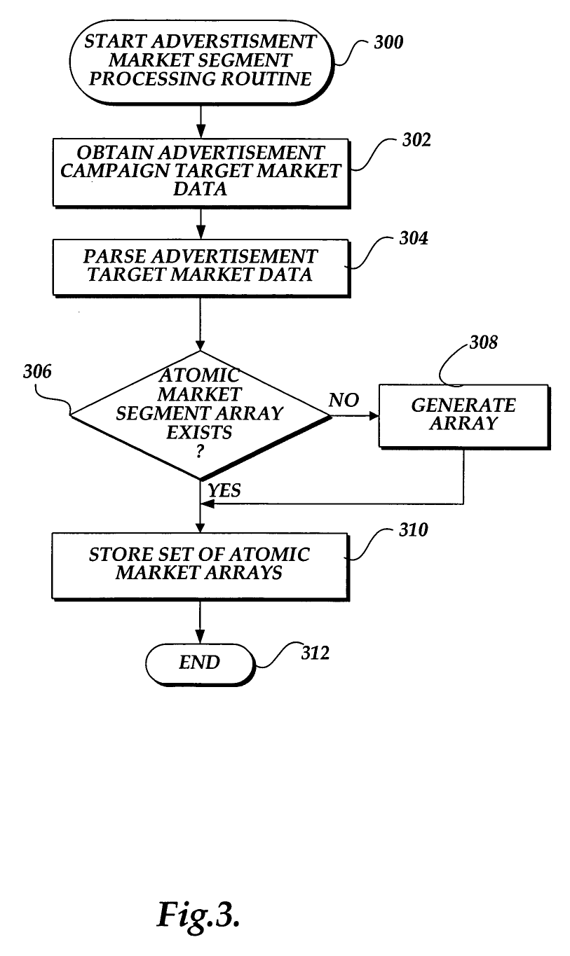

FIG. 3 is a flow diagram illustrative of an advertisement market segment processing routine 300 performed by an advertisement delivery system 108 in accordance with the present invention. At block 302, the advertisement processing component 116 of the advertisement delivery system 108 obtains one or more advertisement target market data (e.g., the data required to be present to select the advertisement) from the advertisement manager component 122. At block 304, the parser 118 from the advertisement processing component 116 parses the advertisement request. In an illustrative embodiment of the present invention, the parser 118 parses the advertisement target market data into an ordered list of individual criterion. At decision block 306, a test is performed to determine whether an atomic market segment array exists for one or more of the parsed target market segment criterion. If one or more of the atomic market segment arrays do not exist, at block 308, the advertisement processing component 116 generates corresponding atomic market segment arrays. At block 310, the advertisement processing component 116 stores the atomic market segment arrays in the atomic market segment data store 120 and the routine 300 terminates at block 312.

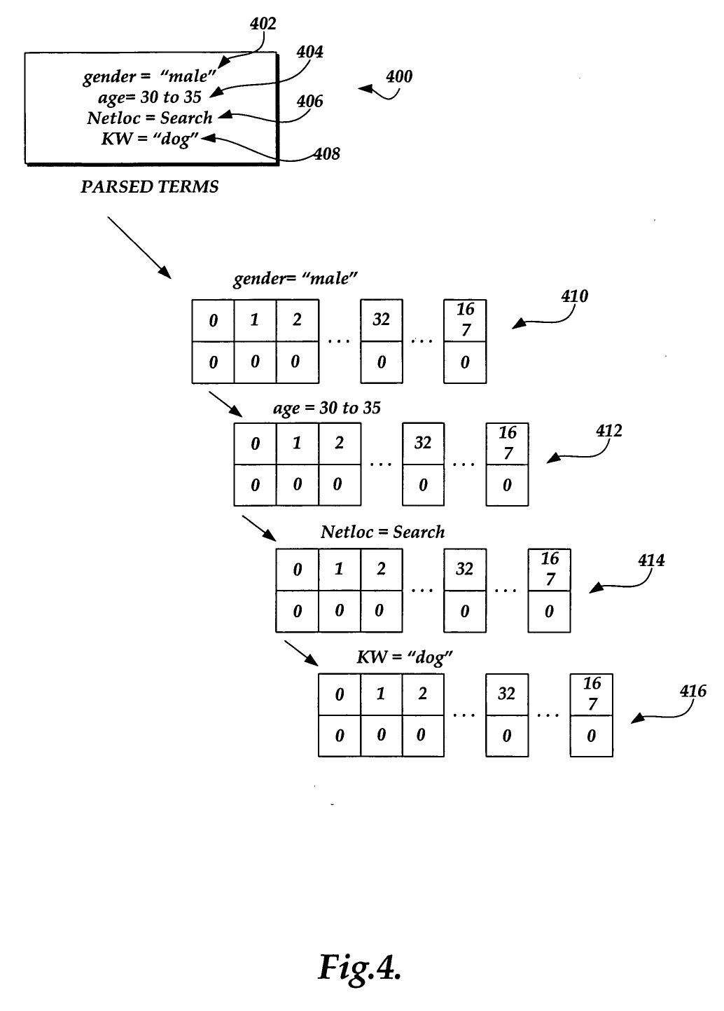

FIG. 4 is block diagram illustrative of the generation of a set of atomic market segment arrays corresponding to inputted advertisement target market segment criteria 400 in accordance with the present invention. In the illustrative example, the parsed advertisement target market segment criteria includes four criteria terms, namely, a “gender=‘male’” term 402, an “age=30 to 35” term 404, a “Netloc=Search” term 406 and a “KW=‘dog’” term 408 are required to be satisfied by inputted advertisement request criteria. In an actual embodiment of the present invention, the advertisement target market segment criteria terms define an available market for potential advertisements, such as the gender and age of the user associated with the client computing device 102, terms 402 and 404, the origin of the content request, term 406, and keywords entered by the user, term 408. In accordance with the present invention, the order of the received terms is maintained during the parsing of the advertisement target market segment criteria for processing. However, one skilled in the relevant art will appreciate that the advertisement delivery system 108 may process the order of the advertisement target market segment criteria in an alternative manner.

In accordance with an illustrative embodiment, the advertisement processing component 116 generates one or more data arrays having elements representative of a time intervals, generally referred to as an atomic market segment array. Each atomic market segment array is associated with an advertisement request term (or related terms) and the data array elements are populated with numerical data indicative of the number of advertisement requests received matching the particular term, or group of terms, that the array represents. Additionally, the population of the array elements with numerical identifiers is structured such that each array element is representative of a time period in which the advertisement request criteria is received. In an actual embodiment of the present invention, each atomic market segment array includes 168 array elements (e.g., element 0-167), in which each array element is indicative of an hour of time. Thus, each array element is capable of monitoring seven days worth of advertisement requests. One skilled in the relevant art will appreciate that variations to the number of array elements in the atomic market segment array or the time period which each array element is representative are considered to be within the scope of the present invention. Moreover, although individual term market segment arrays are illustrated in FIG. 4, the advertisement processing component 116 may also generate one or more atomic market segment arrays representative of a collection of search terms.

In an illustrative embodiment, the one or more atomic market segment arrays are linked according to the order of the parsed advertisement target market segment criteria. With reference to the illustrative example of FIG. 4, the first atomic market segment array 410 corresponds to the first advertisement target market segment criteria term 402, “gender=‘male.’” Similarly, the second atomic market segment array 412 corresponds to the second advertisement target market segment criteria term 404, “age=30 to 35,” the third atomic market segment array 414 corresponds to the third advertisement target market segment criteria 406, and the fourth atomic market segment array 416 corresponds to the fourth advertisement target market segment criteria 408. As will be explained in greater detail below, the array elements of the atomic market segment arrays are now ready to be populated with processed advertisement request information.

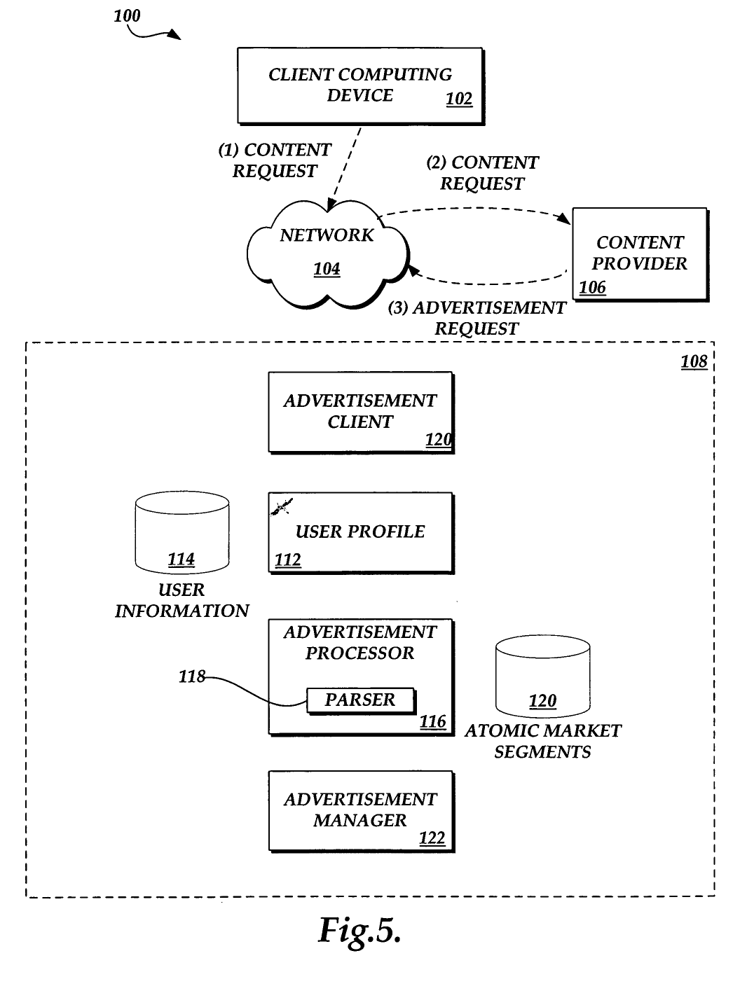

FIGS. 5-9 are block diagrams of the content and advertisement delivery system 100 illustrative of various stages of the processing of a content/advertisement request in accordance with the present invention. Referring to FIG. 5, the process can be initiated when a client computing device 102 generates a content request. In an illustrative embodiment of the present invention, the client computing device 102 may issue a request for content by submitting various information to a content provider. For example, a user associated with the client computing device may submit one or more keywords that relate to a content provider Web site to search for a particular subject matter. Additionally, the client computing device may also submit one or more identifiers, including user demographic information, computing device identifiers, etc., that are stored on the client computing device 102, such as in one or more cookies.

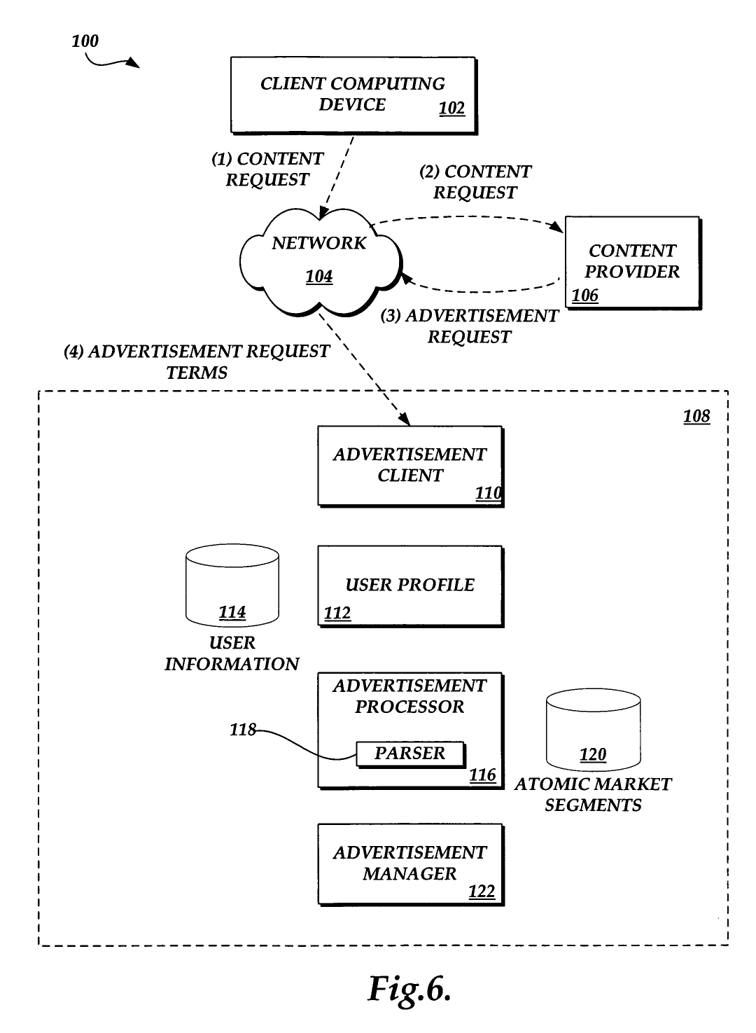

Referring now to FIG. 6, the content provider 106 obtains the client computing device 102 content request and identifies the content corresponding to the request. Additionally, in accordance with the present invention, the content provider generates an advertisement request for one or more advertisements from an advertisement delivery system 108. In an illustrative embodiment of the present invention, the content provider 106 generates advertisement request information that can include the request terms submitted by client computing device 102 and one or more client computing identifiers. As illustrated in FIG. 6, the advertisement request information generated by the client computing device 102 and/or content provider 106 is obtained by the advertisement client component 120 of the advertisement delivery system 108.

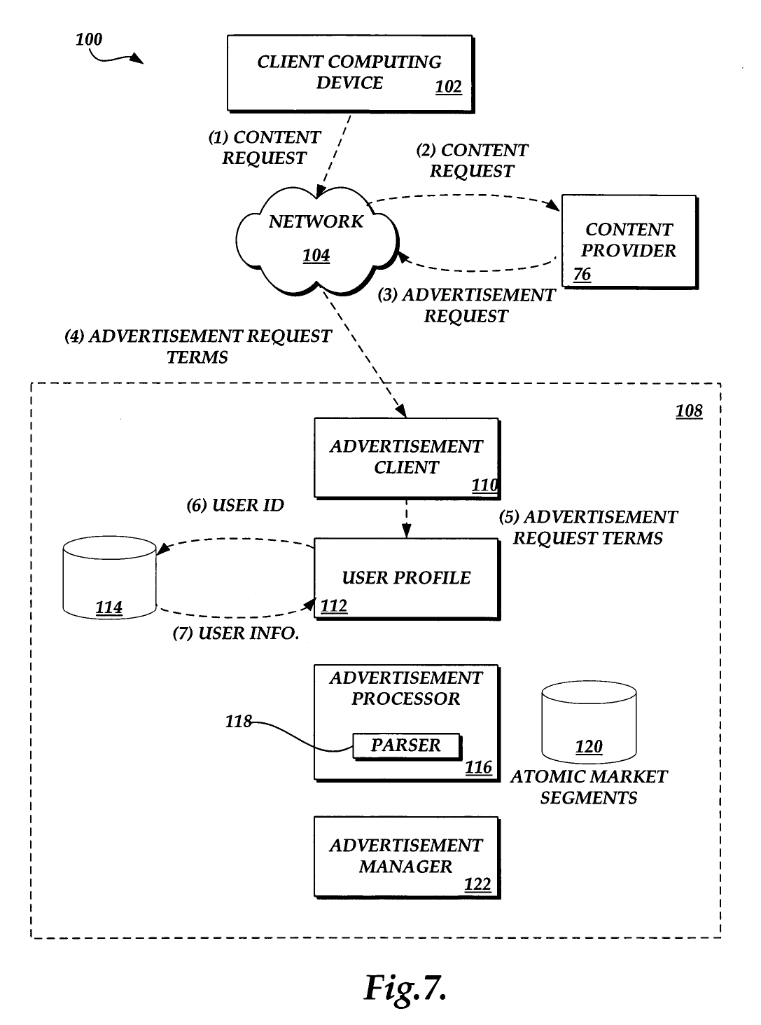

With reference to FIG. 7, the advertisement client component 120 transfers the advertisement request information to a user profile component 112 which can utilize one or more user identifiers within the advertisement request information to obtain additional user information from a user information store 114. For example, the advertisement request information may include a telephone number, address, name or other identifier that can be associated with one or more records from the user information store. The records from the user information store 84 can include more detailed information about a user associated with the client computing device and/or the client computing device itself. In an illustrative embodiment of the present invention, a user may provide a content provider 106 additional user information, such as user demographic information, that is forwarded to the advertisement delivery system 108 for use. Additionally, the user information may include one or more user preferences that will specify a preference for specific subject matter (e.g., sports in Seattle) and/or a preference not to receive advertisements for specific subject matter (e.g., adult material). Accordingly, the information from the user information store 114 is incorporated into the advertisement request information.

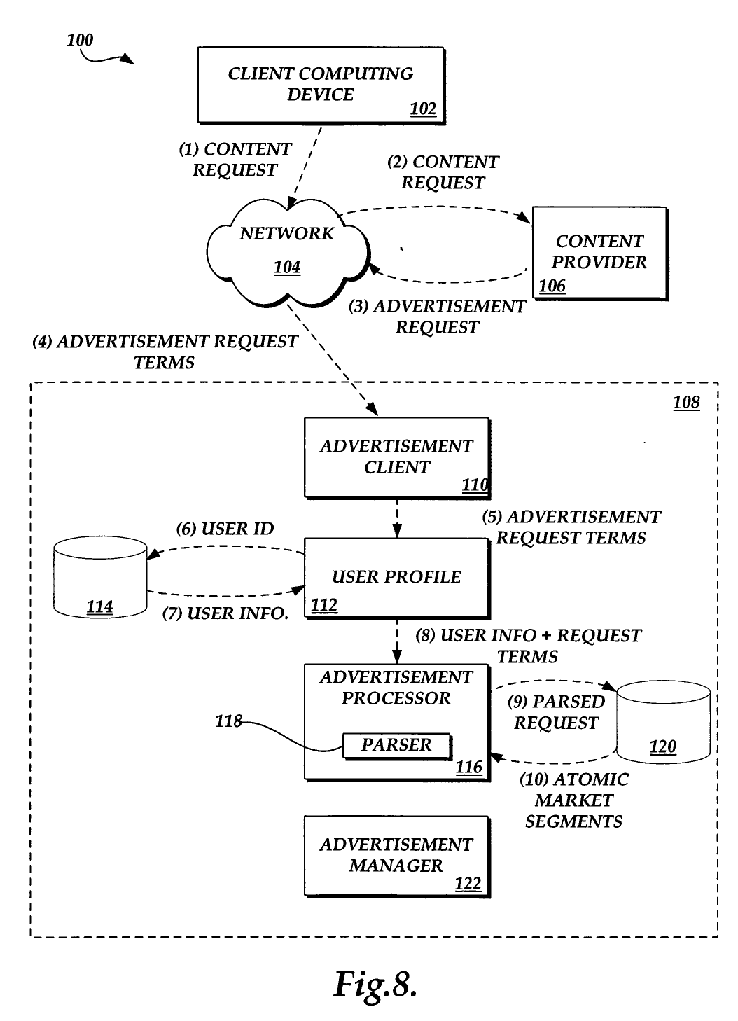

Referring now to FIG. 8, the user profile component 112 transfers the advertisement request information to an advertisement processing component 116 for processing. The advertisement processing component 116 parses the advertisement request information to identify advertisement request criteria to be matched. Additionally, the parsed advertisement request information will be utilized to populate the atomic market segment arrays previously generated by the advertisement processing component 116 for generating future estimate data. In an actual embodiment of the present invention, the selection of an applicable advertisement and the population of the atomic market segment array may be accomplished in a single process. Alternatively, the selection and population function may independent processes.

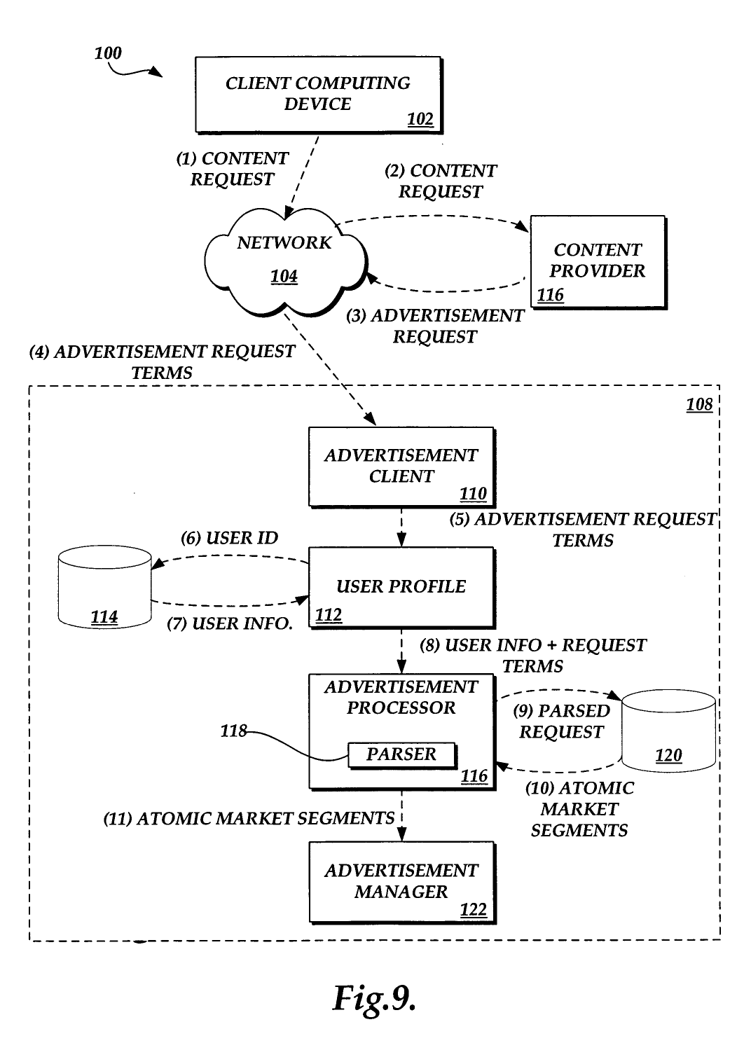

With reference to FIG. 9, the advertisement processing component 116 transfers the atomic market segment data to an advertisement manager component 122 for processing. In an actual embodiment of the present invention, the atomic market segment data is utilized to track current advertisement request data and predict future data. The advertisement manager component 122 may also utilize additional processing to account for overlapping market segments, which will be explained in greater detail below. Additionally, the advertisement manager component may also utilize manual adjustment techniques to account for variations in predictive inventory, as will also be described below.

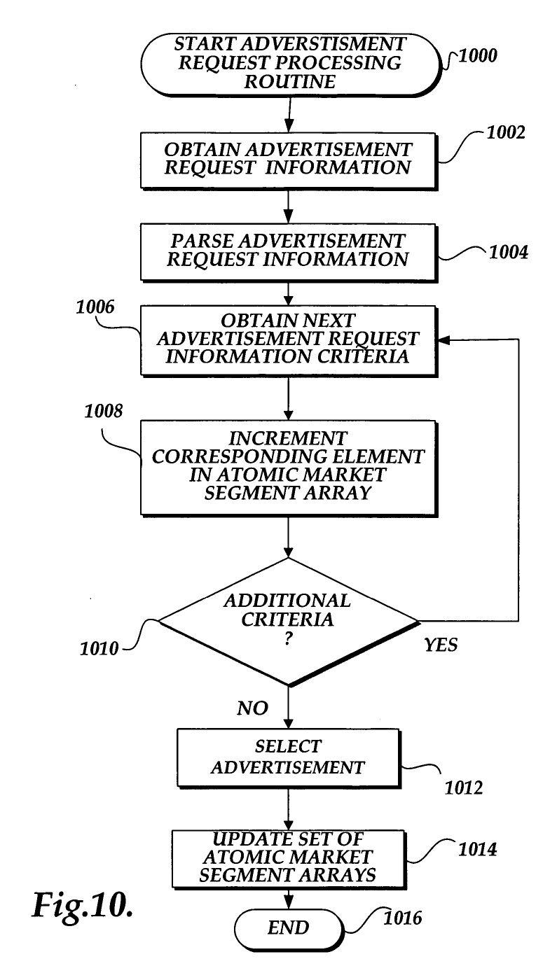

FIG. 10 is a flow diagram illustrative of an advertisement request information processing routine 1000 implemented by the advertisement processing component 116 of the advertisement delivery system 108 in accordance with an illustrative embodiment. At block 1002, the advertisement processing component 116 obtains the advertisement request information including advertisement request criteria. As illustrated in FIGS. 5-8, in an illustrative embodiment of the present invention, the advertisement request information is obtained by an advertisement client component 89 and transferred to a user profile component 112. The user profile component 112 includes additional user information from a user information store 114 and transfers the advertisement request information to the advertisement processing component 116.

At block 1004, the advertisement processing component 116 parses the advertisement request information to generate an ordered list of advertisement information request criterion. In actual embodiment of the present invention, the advertisement processing component 116 maintains the order of the advertisement request information criteria to match with the atomic market segment arrays. However, one skilled in the relevant art will appreciate that the advertisement delivery system 108 may process the order of the advertisement request criteria in an alternative manner, or may not take into account the order of the advertisement request information criteria.

In accordance with an illustrative embodiment, the advertisement processing component 116 processes the parsed advertisement request information by generating multiple combinations of the parsed advertisement request information. The advertisement processing component 116 then attempts to match the combinations with the atomic market segment array data stored in the atomic market segment store 120. At block 1006, the advertisement processing component selects a first advertisement request information criterion and at block 1008 increments an array element in a corresponding atomic market segment array. At decision block 1010, a test is conducted to determine whether any additional advertisement request information criteria remain. If advertisement request information criteria remain, the process 1000 returns to block 1006. If no advertisement request information criteria remain, the process 1000 continues to block 1012, which will be explained in greater detail below.

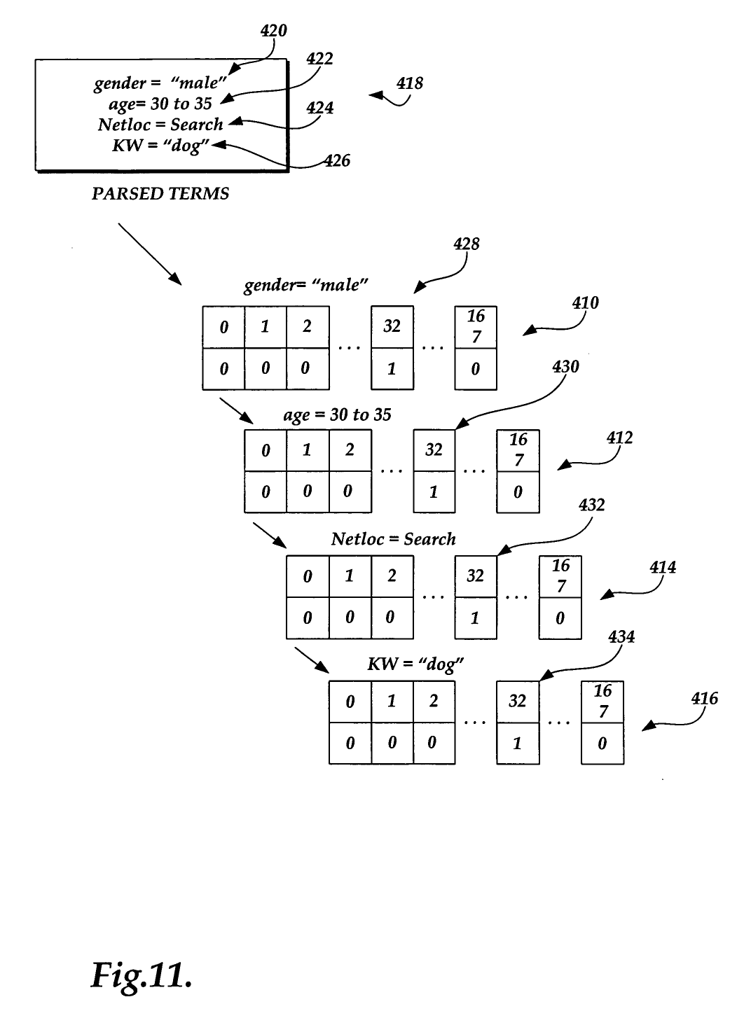

FIG. 11 is a block diagram of the atomic market segment arrays of FIG. 4 illustrating the population of array element by parsed advertisement request criteria in accordance with the present invention. As illustrated in FIG. 11, in the illustrative example, the parsed advertisement request information includes four criteria terms 418, namely, a “gender=‘male’” term 420, an “age=30 to 35” term 422, a “Netloc=Search” term 424 and a “KW=‘dog’” term 426. Assuming that in the illustrative example the advertisement request was received during the 32^{nd} hour of a monitoring period, the 32^{nd} array element 428 of the first atomic market array 410 would be incremented to reflect the received first advertisement request information criteria, namely, “gender=‘male.’” Similarly, the 32^{nd} array elements 430, 432, and 434 of the second, third and fourth atomic market segment arrays 412, 414, 416 would be incremented to correspond to the second, third and fourth terms 422, 424, and 426 of the parsed advertisement request information criteria.

Returning to FIG. 10, once the last advertisement request information criteria has been processed, at block 1012, an appropriate advertisement may be selected. In an illustrative embodiment of the present invention, the advertisement processing component 116 may include indicators in the atomic market segment arrays to indicate when an advertisement is ready for display. Additionally, the advertisement processing component 116 may employ additional methods and systems for selecting from a group of potentially applicable advertisements. At block 1014, the advertisement processing component 116 updates the atomic market segment data according to the processed advertisement request information criteria and stores the updated data in the atomic market segment store. At block 1016, the routine 1000 terminates.

In accordance with the present invention, the advertisement manager component 122 of the advertisement delivery system 108 can utilize the populated atomic market segment data to track current advertisement campaign compliance. Additionally, the advertisement manager component 122 may utilize the populated market segment data to predict future advertisement display opportunities based on historical data. In accordance with this aspect of the present invention, the advertisement manager component 122 may utilize the atomic market segment data to predict future capacity for advertisement campaigns that have target market segments that directly match a current advertisement campaign. For example, the advertisement manager component 122 may apply a forecasting method, such as a least-square method or a linear regression method, to predict future display opportunities for different predicted volumes of advertisement requests. One skilled in the relevant art will appreciate that any one of a variety of trend analysis may be utilized to predict future trends in data points and are considered within the scope of the present invention.

In conjunction with predicting future display opportunities for advertisement campaigns having matching target markets, the advertisement manager component 122 may utilize set theory and probability theory to compute a percentage of overlaps between different target market segments in processing the populated target market segment array data. One skilled in the relevant art will appreciate that between two advertisement campaigns, the target market segments of the campaigns may either be disjoint, fully contained or intersecting. If the target market segments are disjoint, the campaigns do not share any common values for target market segment criteria. If the target market segment criteria are fully contained, then one advertisement campaign has identical target market segment criteria values as the other advertisement campaign. For example, a target market for one advertisement campaign may have a parent/child relationship with a second advertisement campaign. Additionally, the advertisement campaign has additional target market segment criteria values that do not satisfy the other advertisement campaign's target market segment criteria values. Finally, if the target market segments are intersecting, the campaigns share some portion of matching target market segment criteria values.

As applied to the present invention, in one aspect, the advertisement manager component 122 utilizes set theory and probability theory to calculate potential capacity for future advertisement campaigns not directly matching the target market segments of any current campaigns. For example, because it may not be practical for an advertisement delivery system 108 to store every possible permutation of advertisement request, the advertisement delivery system 108 utilizes set and probability theories to manage various future advertisement campaigns having evaluation criterion that are combinations of current advertisement campaign atomic market segment data. Additionally, in another aspect, the advertisement manager component 122 utilizes set theory and probability theory to reduce capacity numbers for predicted advertisement display opportunities if one or more advertisement campaigns may have some overlap in display opportunities, such as in an overlapping or fully contained market segment.

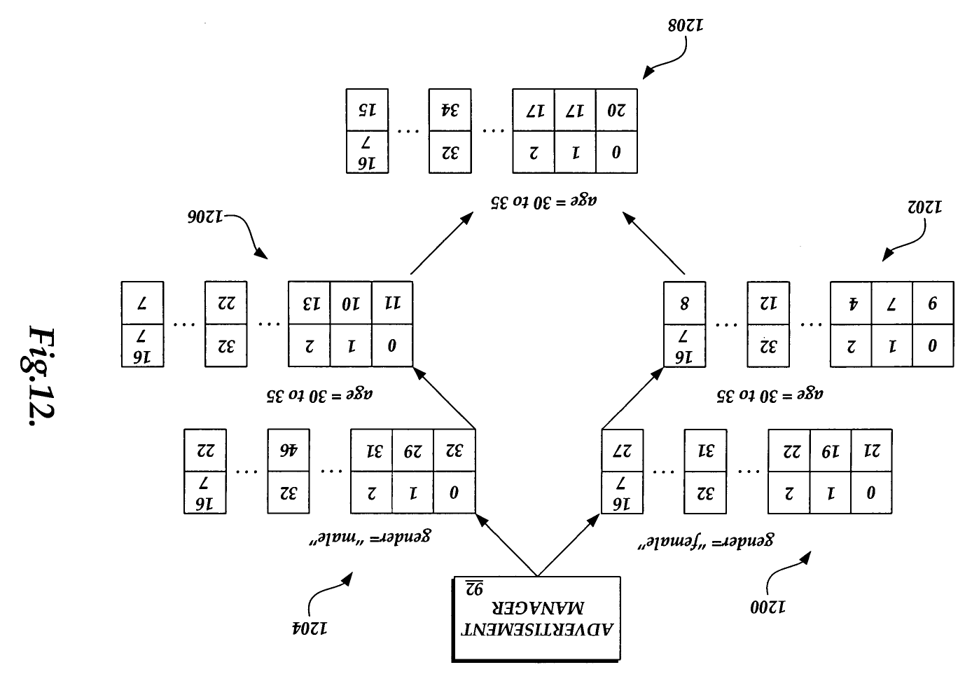

FIG. 12 is a block diagram illustrating the generation of a predicted number of advertisement display opportunities from overlapping market segments in accordance with the present invention. In an illustrative example, assume that an advertisement manager component 122 needs to calculate a total number of advertisement request information criteria that included the term “age=30 to 35” and that it was not a first criteria in any advertisement campaign target market segment criteria order. Accordingly, as illustrated in FIG. 12, the advertisement manager component 122 obtains two sets atomic market segment arrays from the advertisement processing component 116. The first set of atomic market segment arrays includes an atomic market array 1200 corresponding to “gender=‘female’” and an atomic market segment array 1202 corresponding to “age=30 to 35.” The second set of atomic market segment arrays includes an atomic market array 1204 corresponding to “gender=‘male’” and an atomic market segment 1206 corresponding to “age=30 to 35.” One skilled in the relevant art will appreciate that the addition of atomic market segment array 1204 and atomic market segment array 1206 would yield a total number of advertisement request information criteria including the terms “age=30 to 35,” as illustrated in atomic market segment array 1208. Thus, the advertisement manager component 122 may utilize the forecasting method to predict the total number of advertisement request information criteria that will include the term “age=30 to 35.”

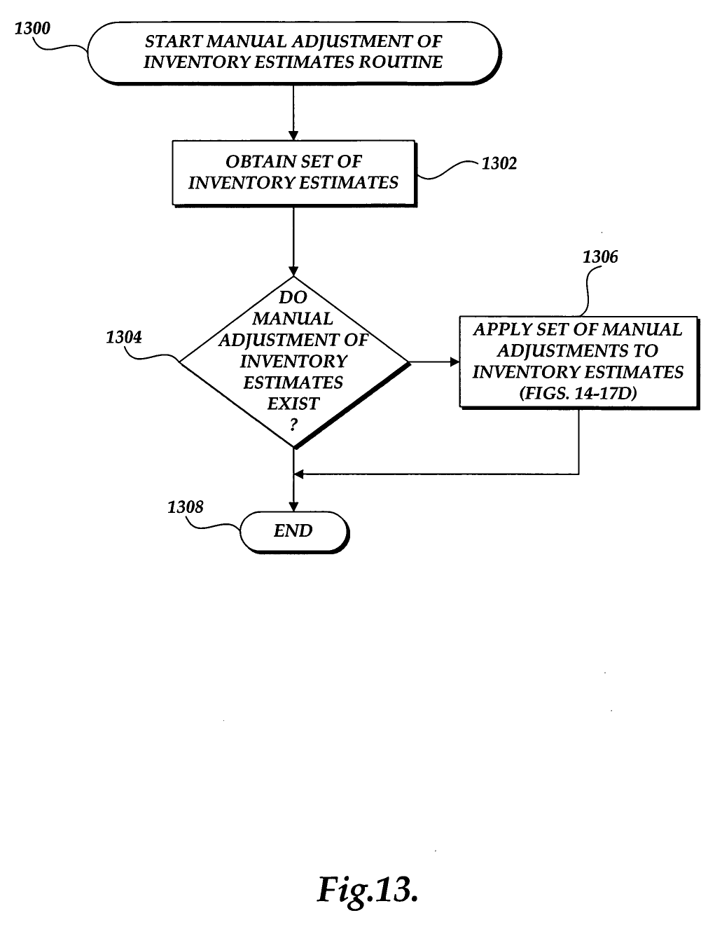

In accordance with another aspect of the present invention, the advertisement manager component 122 may also utilize various manual adjustment techniques to adjust predictive inventory. FIG. 13 is a flow diagram illustrative of a routine 1300 for adjusting predictive future inventory estimates, implemented by the advertisement manager component 122, in accordance with the present invention. At block 1302, the advertisement manager component 122 obtains a predictive set of inventory, such as atomic market segment array 1208 (FIG. 12). At decision block 1304, a test is conducted to determine whether the predictive inventory has been designated to be manually adjusted. In an illustrative embodiment, information can be associated with a set of predictive inventory that designate the predictive inventory as requiring manual adjustment. Additionally, the information can provide additional context as to the type of manual adjustments that will be performed and possible application dates for the designated adjustment.

One skilled in the relevant art will appreciate that predictive inventory may be designated for manual adjustments for a variety of reasons. In one embodiment, the manual adjust of predictive inventory can be initiated for atomic market segments in which a statistically insignificant amount of data has been collected. In another embodiment, the manual adjustment of predictive inventory can be initiated to account for seasonal or cyclical occurrences. In still another embodiment, the manual adjustment of predictive inventory can be initiated to account for event drive occurrences or based upon additional information collected by the advertisement manager component 122. In an illustrative embodiment, the manual adjustments may be applied at run time with the receipt of the predictive data.

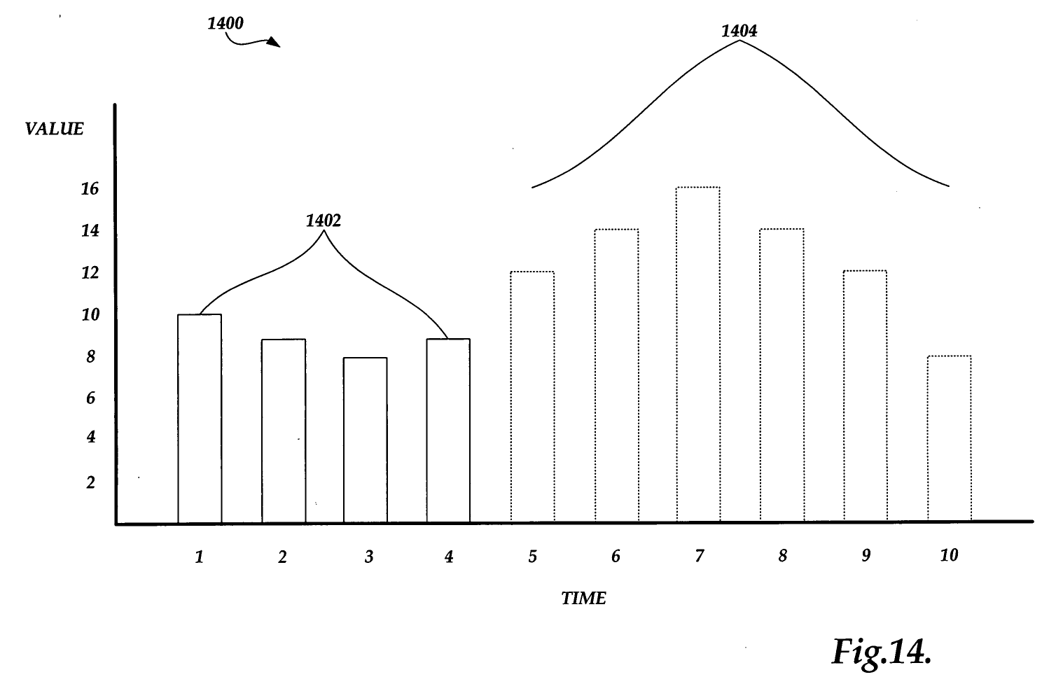

If the predictive inventory requires manual adjustment, at block 1306, the advertisement manager component 122 applies one or more manual adjustments to the predictive inventory data. In an illustrative embodiment, one of the manual adjustments corresponds to a seed value that is utilized to set predictive values of future inventory to a specified level. In another embodiment, the manual adjustments can correspond to an adjustment (either increase or decrease) of the predictive values of future inventory. In this embodiment, the current value of at least a portion of the predictive value of future inventory is adjusted by an adjustment factor that corresponds to a straight value or percentage that is applied to the original predictive value. In still another embodiment, the manual adjustments can correspond to a proxy of predictive values of future inventory. In this embodiment, at least a portion of the predictive inventory values of future inventory is replaced with a proxy value from another target market segment. Illustrative examples of the various manual adjustment techniques corresponding to block 1306 will be illustrated with regard to FIGS. 14-17D. At block 1308, the routine 1300 terminates.

In an illustrative embodiment, the various manual adjustment techniques may be applied to all the predictive values. Alternatively, the various manual adjustment techniques may apply to a subset of values indicative of a range of applicability. For example, a seed value may be specified for a period of time that corresponds to a special event, such as the holiday season. In another illustrative embodiment, one or more of the manual techniques may be combined. In one aspect, manual adjustment techniques may be combined to generate a desired result. For example, the manual adjustment may correspond to a proxy value combined with a percentage adjustment. In another aspect, unrelated, manual adjustments may happen to overlap to generate a combined effect on the predictive data. For example, a proxy value manual technique may be specified based a first event. Additionally, an adjustment factor manual technique may be specified based on a second event. If the applicability range for both adjustment techniques overlap, the predictive data would be adjusted by the combination of the manual techniques.

As illustrated above, available inventory for a target advertisement campaign can correspond to a combination of a hierarchically arranged market segment arrays. In an illustrative embodiment, the various manual adjustment techniques may be applied to different market segment arrays along the hierarchy. For example, a seed value market adjustment may be applied to the combination of market segment arrays to set a fixed inventory estimate for the combination. In contrast, a 20% adjustment factor may be applied to a particular criterion (e.g., Age=18-24). The effect of the 20% adjustment will be depend on the hierarchical location of the criterion.

FIGS. 14-16 block diagrams illustrative of predictive and current values of inventory for a target advertisement campaign in accordance with an aspect of the present invention. With reference to FIG. 14, the predictive and current values for a target advertisement campaign 1400 can be represented in chart of values in the vertical axis versus discrete time units in the horizontal axis. As discussed above with regard to FIG. 4, the discrete time units can correspond to various time increments, such as hours. As illustrated in FIG. 14, the chart can include a series of current values 1402 that can correspond to actual sampled values. Additionally, the chart can include a series of predictive values 1404 that correspond to values extrapolated by the advertisement manager component 122. As discussed above, the predictive values 1404 can be can be calculated utilizing mathematical forecasting techniques such as linear regression.

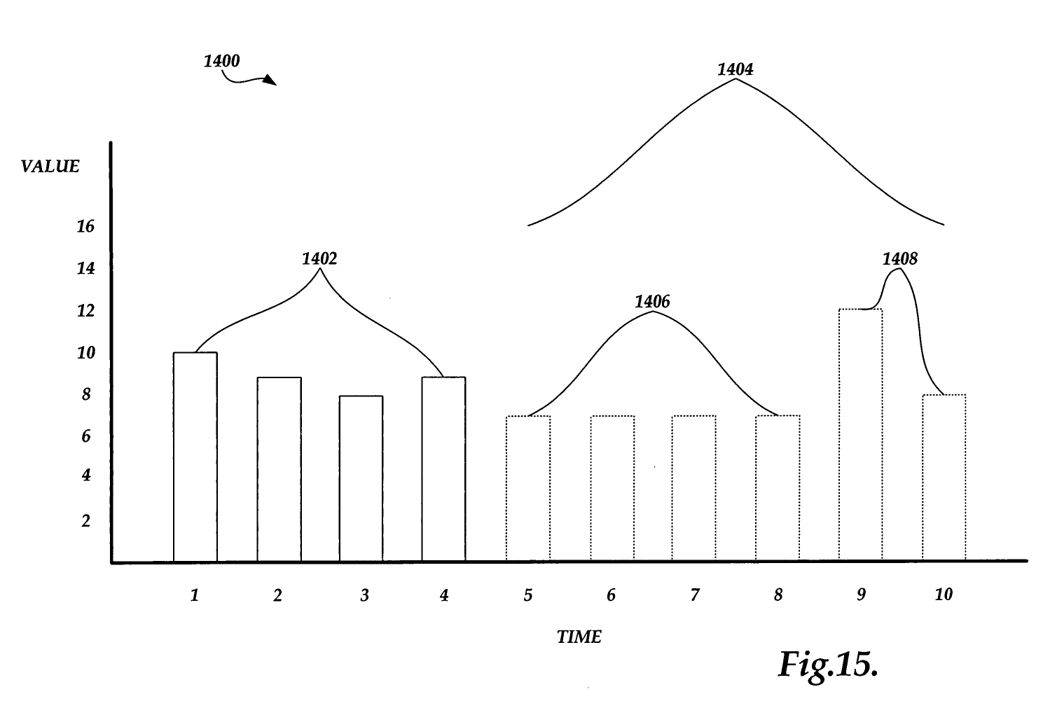

With reference to FIG. 15, in accordance with one embodiment, seed values may be utilized in accordance with a manual adjustment of the predictive and current values of inventory for a target advertisement campaign 1400. As illustrated in FIG. 15, the predictive and current values of inventory for a target advertisement campaign 1400 includes the original series of current values 1402. However, the chart includes a series of predictive values 1406 in which a seed value has been substituted for the previously forecast value. In this embodiment, the predictive value will remain flat for the series of values 1406. In an illustrative embodiment, the manual adjustment can affect all the predictive values in a target advertisement campaign. Alternatively, the manual adjustment can correspond to only a subset of predictive values. As also illustrated in FIG. 15, the chart also includes a series of predictive values 1408 that correspond to the previously forecast predictive values and which were not affected by the manual adjustment.

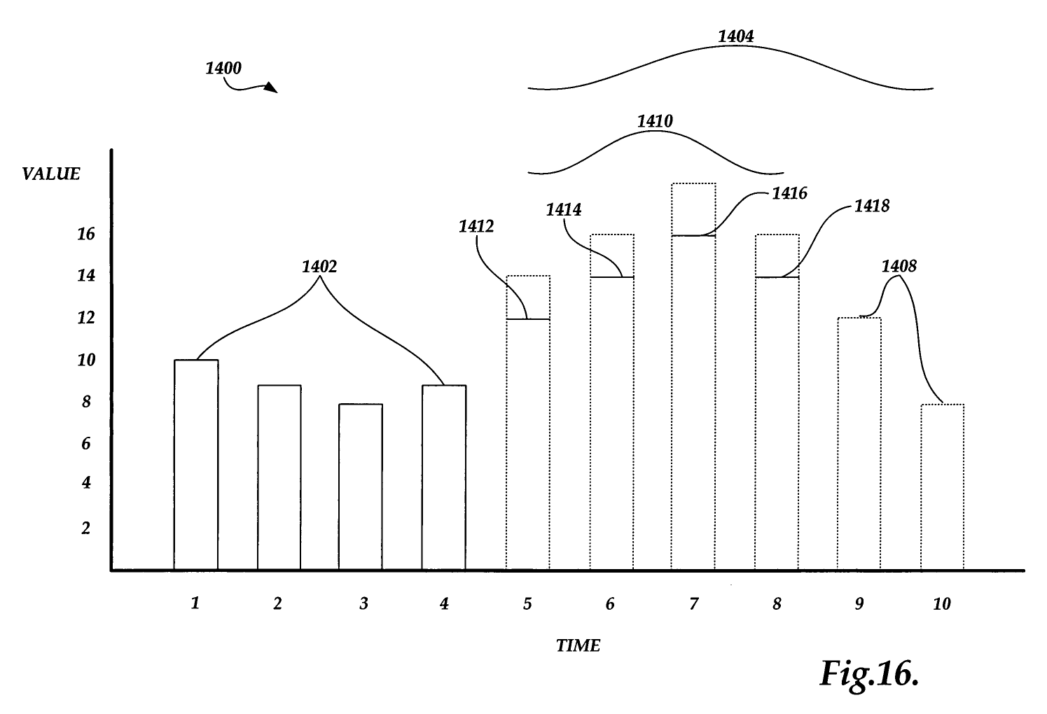

With reference now to FIG. 16, in accordance with another embodiment, adjustment values may be utilized in accordance with a manual adjustment of the predictive and current values of inventory for a target advertisement campaign 1400. As illustrated in FIG. 16, the predictive and current values of inventory for a target advertisement campaign 1400 includes the original series of current values 1402. However, the chart includes a series of predictive values 1410 in which an adjustment factor has been applied to the previously forecast values. In one aspect, the adjustment factor may a hard value that is applied (as either an increase or a decrease) to all the predictive values in the series 1410. In another aspect, the adjustment factor may be a percentage that is applied (as either an increase or a decrease) to all the predictive values in the series. As illustrated in FIG. 16, the previous values 1412, 1414, 1416, 1418 of the series of predictive values 1410 have been incremented by a factor of “2.” Similar to FIG. 15, the chart also includes a series of predictive values 1408 that correspond to the previously forecast predictive values and which were not affected by the manual adjustment.

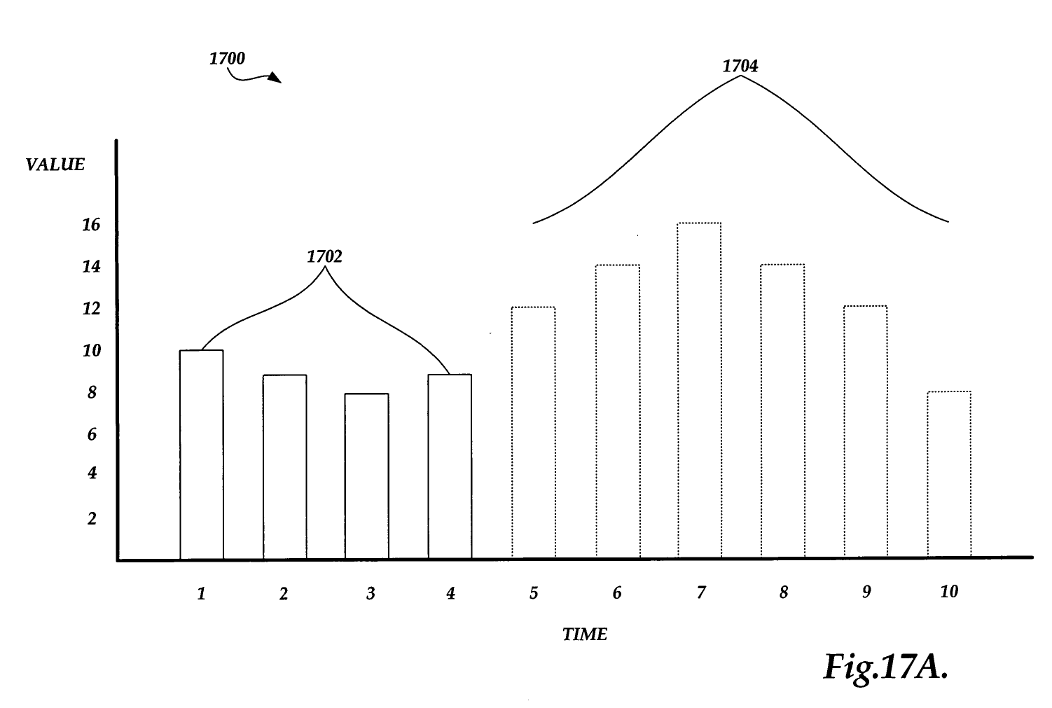

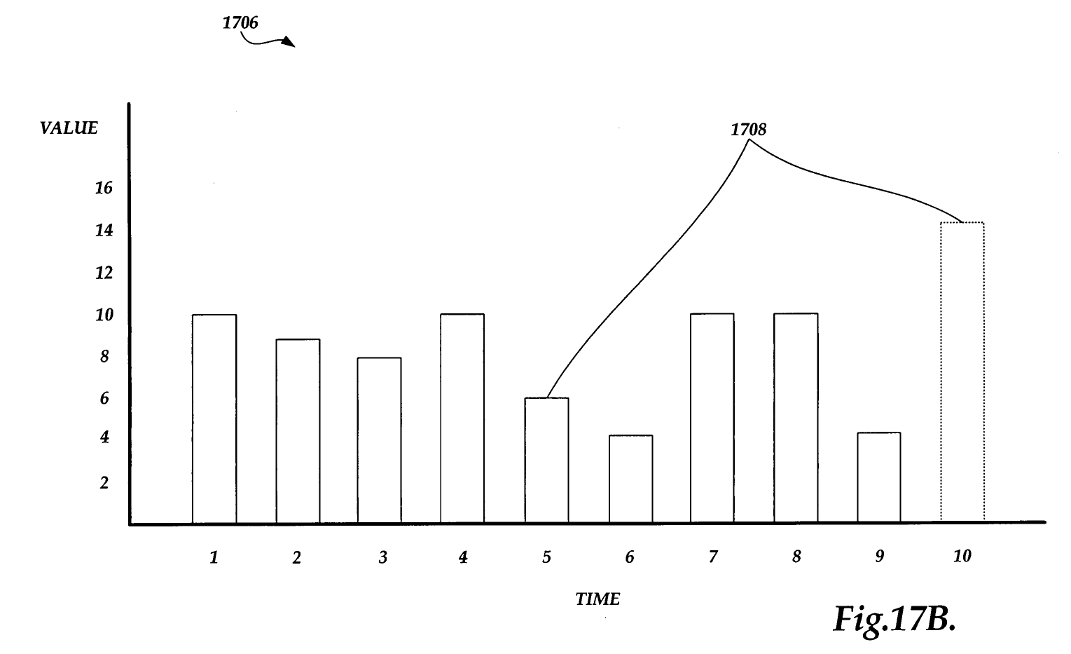

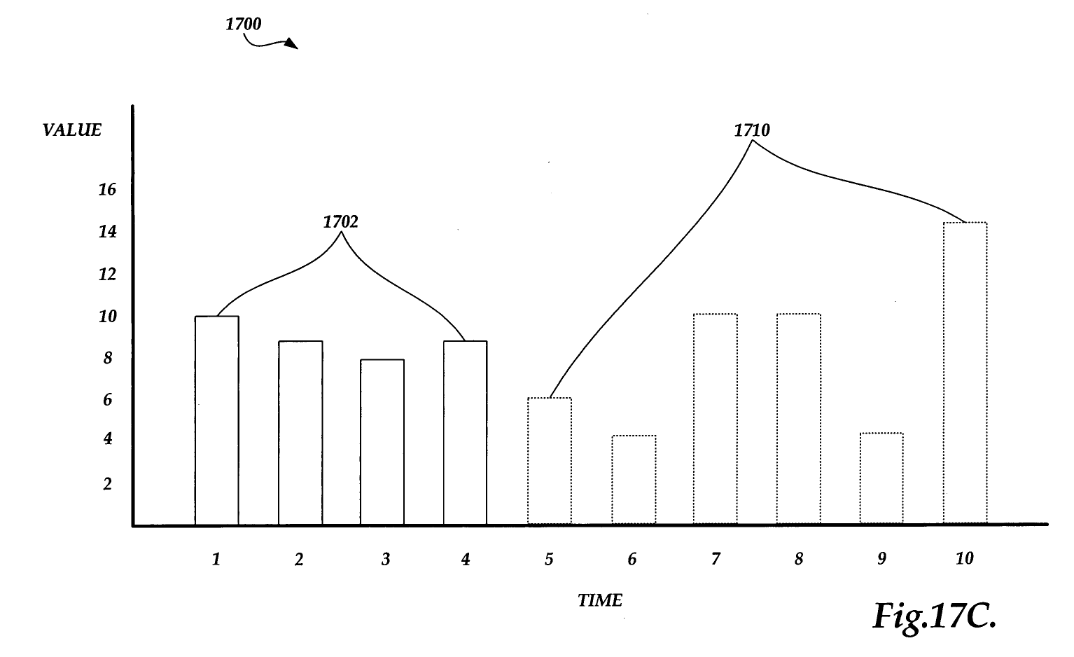

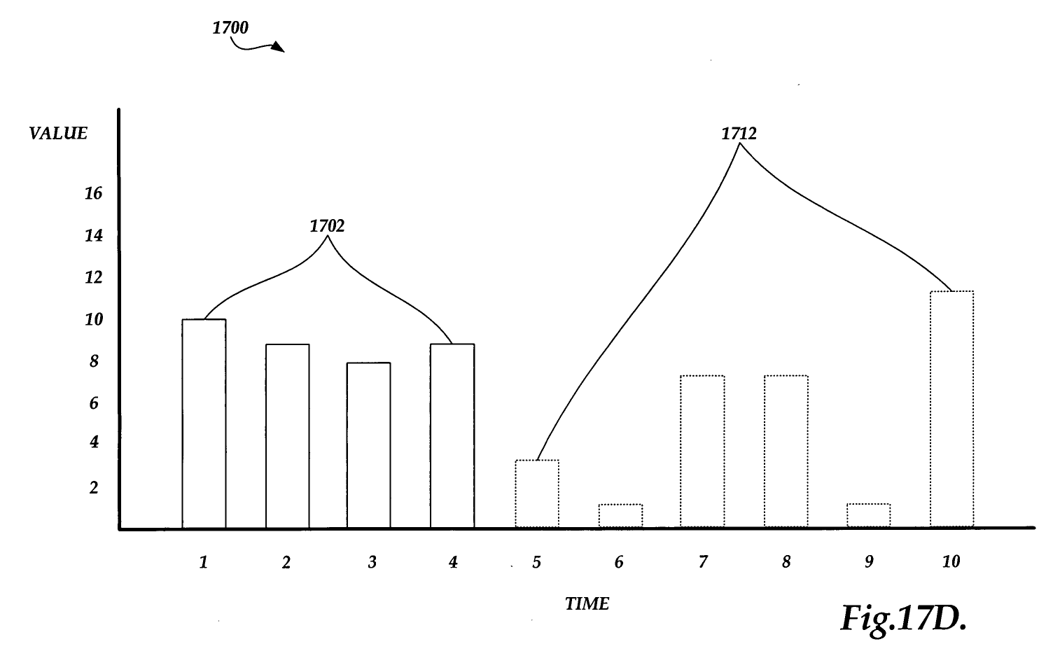

FIGS. 17A-17D are also block diagrams illustrative of predictive and current values of inventory for a target advertisement campaign in accordance with an aspect of the present invention. Similar to FIG. 14, a chart of predictive and current values for a target advertisement campaign 1700 can include a series of current values 1702 that can correspond to actual sampled values. Additionally, the chart can include a series of predictive values 1704 that correspond to values extrapolated by the advertisement manager component 122. In accordance with an embodiment, the advertisement manager component 122 manually adjusts the predictive and current values of inventory for a target advertisement campaign 1700 utilizing proxy inventory values for another campaign. With reference to FIG. 17B, for illustrative purposes a proxy inventory value 1706 can include at least one series of current or predictive values 1708. The series of current or predictive values 1708 does not have to correspond to the same time intervals for the predictive values of the target advertisement campaign.

With reference now to FIG. 17C, the predictive and current values of inventory for a target advertisement campaign 1700 has been manually adjusted by replacing the original series of predictive values 1704 with the values 1708 of the proxy target advertisement campaign. Accordingly, series 1710 mirrors values 1708. With reference now to FIG. 17D, the resulting combination of predictive and current values illustrated in FIG. 17C may be further adjusted by a combination with other manual adjustment techniques. As illustrated in FIG. 17D, the predictive values 1712 corresponding to the series of proxy values 1708 (FIG. 17B) have been reduced by incorporating an adjustment factor.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. A method for processing payload requests, the method comprising:
obtaining a set of criteria for delivering at least one payload, the set of criteria including one or more criterion;
generating a set of arrays corresponding to each criterion in the set of criteria, the set of arrays including a plurality of array elements corresponding to periods of time;
processing numerical identifiers in the set of arrays to predict an estimated number of future payload requests; and
manually adjusting at least a portion of the estimated number of future payload requests.

2. The method as recited in claim 1, wherein processing the numerical identifiers includes applying a trend analysis.

3. The method as recited in claim 1, wherein manually adjusting at least a portion of the estimated number of future payload requests includes setting at least a portion of the numerical identifiers in the set of arrays to a fixed value.

4. The method as recited in claim 3, wherein manually adjusting at least a portion of the estimated number of future payload requests includes applying an adjustment factor to at least a portion of the numerical identifiers in the set of arrays.

5. The method as recited in claim 4, wherein the adjustment factor is a fixed value that is applied to the estimated number of future payload requests.

6. The method as recited in claim 4, wherein the adjustment factor is a percentage that is applied to the estimated number of future payload requests.

7. The method as recited in claim 1, wherein manually adjusting at least a portion of the estimated number of future payload requests includes associating a proxy value to at least a portion of the estimated number of future payload requests.

8. The method as recited in claim 1, wherein manually adjusting at least a portion of the estimated number of future payload requests includes selecting two or more manual adjustment techniques.

9. The method as recited in claim 1, wherein manually adjusting at least a portion of the estimated number of future payload requests includes manually adjusting a range of the estimated number of future payload requests.

10. A method for processing payload requests, the method comprising:
obtaining a set of criteria for delivering at least one payload, the set of criteria including one or more criterion;
generating a set of arrays corresponding to each criterion in the set of criteria, the set of arrays including a plurality of array elements corresponding to periods of time;
obtaining a request for a payload, the payload request including a set of request having one or more criterion wherein the payload request is associated with a time; and
incrementing a numerical identifier in the set of arrays corresponding to the time associated with the payload request;
processing the numerical identifiers in the set of arrays to predict an estimated number of future payload requests; and
manually adjusting at least a portion of the estimated number of future payload requests.

11. The method as recited in claim 10, wherein manually adjusting at least a portion of the estimated number of future payload requests includes setting at least a portion of the estimated number of future payload requests to a fixed value.

12. The method as recited in claim 10, wherein manually adjusting at least a portion of the estimated number of future payload requests includes applying an adjustment factor to at least a portion of the estimated number of future payload requests.

13. The method as recited in claim 10, wherein manually adjusting at least a portion of the estimated number of future payload requests includes associating a proxy value to at least a portion of the estimated number of future payload requests.

14. The method as recited in claim 10, wherein manually adjusting at least a portion of the numerical identifiers in the set of arrays includes applying a proxy value and an adjustment factor to at least a portion of the numerical identifiers in the set of arrays.

15. The method as recited in claim 10, wherein manually adjusting at least a portion of the estimated number of future payload requests includes manually adjusting a range of the estimated number of future payload requests.

16. A system for processing payload requests, the payload requests associated with a set of payload criteria having one or more criterion, the system comprising:
a payload processor operable to obtain the payload criteria and generate a set of arrays corresponding to each criterion in the set of payload criteria; and
a payload manager operable to obtain the set of arrays and to process data within the set of arrays to generate an estimated number of future payload requests, wherein the payload manager manually adjusts a least a portion of the estimated number of future payload requests.

17. The system as recited in claim 16, wherein the payload manager manually adjusts at least a portion of the estimated number of future payload requests by setting at least a portion of the estimated number of future payload requests to a fixed value.

18. The system as recited in claim 16, wherein the payload manager manually adjusts at least a portion of the estimated number of future payload requests by applying an adjustment factor to least a portion of the estimated number of future payload requests.

19. The system as recited in claim 16, wherein the payload manager manually adjusts at least a portion of the estimated number of future payload requests by associating a proxy value to least a portion of the estimated number of future payload requests.

20. The system as recited in claim 16, wherein the payload manager manually adjusts at least a portion of the estimated number of future payload requests by associating a proxy value and applying an adjust factor to least a portion of the estimated number of future payload requests.
